(19) United States
(12) Patent Application Publication
(10) Pub. No.: US 2026/0229410 A1
(43) Pub. Date: Aug. 6, 2026

(54) MULTILAYER ELECTRONIC COMPONENT

(71) Applicant: SAMSUNG ELECTRO-MECHANICS CO., LTD., Suwon-si (KR)

(72) Inventor: Young Jun CHA, Suwon-si (KR)

(73) Assignee: SAMSUNG ELECTRO-MECHANICS CO., LTD., Suwon-si (KR)

(21) Appl. No.: 19/438,838

(22) Filed: Jan. 2, 2026

(30) Foreign Application Priority Data
Feb. 4, 2025 (KR) 10-2025-0013707

(51) Int. Cl. H01G 4/224; H01G 4/005; H01G 4/232; H01G 4/248; H01G 4/30

(52) U.S. Cl. CPC H01G 4/224; H01G 4/005; H01G 4/232; H01G 4/248; H01G 4/30

(57) ABSTRACT

A multilayer electronic component includes a body having a capacitance formation portion with dielectric layers and internal electrodes alternately stacked in a thickness direction, and a cover portion disposed on the capacitance formation portion. The cover portion includes at least one dummy electrode exposed on a side surface of the body. An external electrode includes a connection portion on opposite end surfaces of the body and a side portion extending to cover the dummy electrode. A ratio of a width of the side portion to a width of a band portion is between 40% and 100%, and a ratio of a thickness of the side portion to a thickness of the external electrode is between 4% and 50%, improving bonding strength and reliability.

### CROSS-REFERENCE TO RELATED APPLICATION(S)

This application claims the benefit of priority to Korean Patent Application No. 10-2025-0013707 filed on Feb. 4, 2025 with the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom.

An MLCC may be used as a component of various electronic devices due to having a small size, ensuring high capacitance and being easily mounted. With the miniaturization and high-output power of various electronic devices such as computers and mobile devices, demand for miniaturization and implementation of high capacitance of MLCCs has also been increasing.

In MLCCs having reduced thickness simultaneously with reduced size, when securing design space and controlling thickness variation of an external electrode are prioritized, a side portion of the external electrode may not be formed to have a sufficient size. When the side portion of the external electrode is not formed to have a sufficient size, various issues, such as delamination of a plating layer or the entire side surface portion of the external electrode, may occur due to insufficient bonding strength between a body and the external electrode.

### SUMMARY

An aspect of the present disclosure is to provide a multilayer electronic component having excellent bonding strength between a body and an external electrode.

Another aspect of the present disclosure is to improve a step portion caused by repeated lamination of dielectric layers and internal electrodes.

However, the aspects of the present disclosure are not limited to those set forth herein, and will be more easily understood in the course of describing specific example embodiments of the present disclosure.

According to an aspect of the present disclosure, there is provided a multilayer electronic component including a body including a capacitance formation portion including a dielectric layer and an internal electrode alternately disposed with the dielectric layer in a thickness direction, and a cover portion disposed on the capacitance formation portion in the thickness direction, the body having first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction, an external electrode including a connection portion disposed on the fifth and sixth surfaces, and a band portion disposed to extend from the connection portion onto the first and second surfaces. The cover portion may include at least one dummy electrode exposed to at least one of the third and fourth surfaces. The external electrode may include a side portion extending from the band portion onto at least one of the third and fourth surfaces, the side portion disposed to cover the dummy electrode exposed to at least one of the third and fourth surfaces. A ratio (SBW/BW) of a size in the width direction (SBW) of the side portion to a size in the width direction (BW) of the band portion may satisfy 40%≤SBW/BW≤100%. A ratio (SBT/ET) of a size in the thickness direction (SBT) of the side portion to a size in the thickness direction (ET) of the external electrode may satisfy 4%≤SBT/ET≤50%.

According to another aspect of the present disclosure, there is provided a multilayer electronic component including a body including a capacitance formation portion including a dielectric layer and an internal electrode alternately disposed with the dielectric layer in a thickness direction, and a cover portion disposed on the capacitance formation portion in the thickness direction, the body having first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction, and an external electrode including a connection portion disposed on the fifth and sixth surfaces, and a band portion disposed to extend from the connection portion onto the first and second surfaces. The cover portion may include at least one dummy electrode exposed to at least one of the third and fourth surfaces. The external electrode may include a side portion extending from the band portion onto at least one of the third and fourth surfaces, the side portion disposed to cover the dummy electrode exposed to at least one of the third and fourth surfaces. A ratio (SBW/BW) of a size in the width direction (SBW) of the side portion to a size in the width direction (BW) of the band portion may satisfy 46%≤SBW/BW≤100%. A thickness (T) of the multilayer electronic component may satisfy 0.05 mm≤T≤0.3 mm.

According to another aspect of the present disclosure, there is provided a multilayer electronic component including a body including a capacitance formation portion including a dielectric layer and an internal electrode alternately disposed with the dielectric layer in a thickness direction, and a cover portion disposed on the capacitance formation portion in the thickness direction, the body having first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction, and an external electrode including a connection portion disposed on the fifth and sixth surfaces, and a band portion disposed to extend from the connection portion onto the first and second surfaces. The cover portion may include at least one dummy electrode exposed to at least one of the third and fourth surfaces. The external electrode may include a side portion extending from the band portion onto at least one of the third and fourth surfaces, the side portion disposed to cover the dummy electrode exposed to at least one of the third and fourth surfaces. A ratio (SBT/ET) of a size in the thickness direction (SBT) of the side portion to a size in the thickness direction (ET) of the external electrode may satisfy 7%≤SBT/ET≤50%. A thickness (T) of the multilayer electronic component may satisfy 0.05 mm≤T≤0.3 mm.

According to example embodiments of the present disclosure, bonding strength between a body and an external electrode of a multilayer electronic component may be improved.

According to example embodiments of the present disclosure, a step portion caused by a dielectric layer and an internal electrode of a multilayer electronic component may be improved.

However, the various advantages and effects of the present disclosure are not limited to those set forth herein, and will be more easily understood in the course of describing specific exemplary embodiments of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an exemplary embodiment of the present disclosure;

FIG. 2 is a schematic cross-sectional view taken along line I-I′ of FIG. 1;

FIG. 3 is a schematic side view of a multilayer electronic component of FIG. 1 as viewed in an X-direction;

FIG. 4 is a schematic side view of a multilayer electronic component according to another exemplary embodiment of the present disclosure as viewed in an X-direction;

FIGS. 5A and 5B are schematic views of an internal electrode shape;

FIGS. 6A and 6B are schematic views of an internal electrode shape and a buffer electrode shape;

FIGS. 7A and 7B are schematic views of a dummy electrode shape of a cover portion; and

FIGS. 8A and 8B are schematic views of another dummy electrode shape of a cover portion.

### DETAILED DESCRIPTION

Hereinafter, exemplary embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and lengths are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a Z-direction may be defined as a thickness direction or a first direction, an X-direction may be defined as a length direction or a second direction, and a Y-direction may be defined as a width direction or a third direction.

In addition, in the present disclosure, a thickness may refer to a size in a first direction, a length may refer to a size in a second direction, and a width may refer to a size in a third direction.

### Multilayer Electronic Component

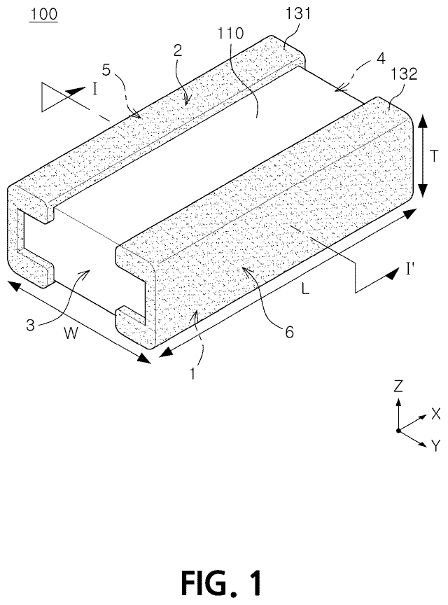

FIG. 1 is a schematic perspective view of a multilayer electronic component according to an exemplary embodiment of the present disclosure.

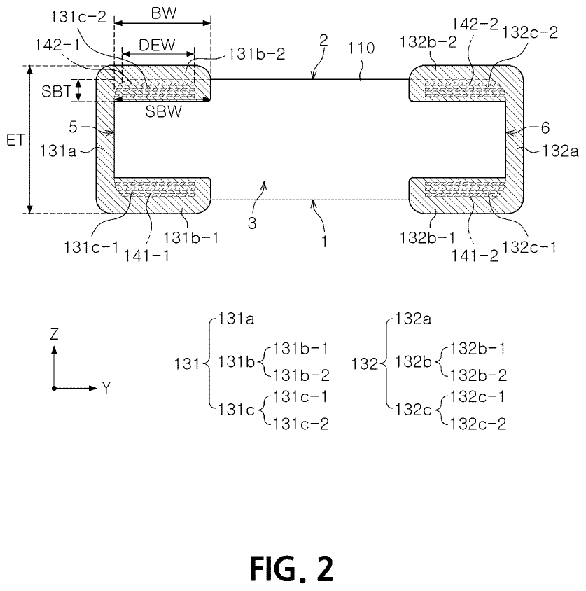

FIG. 2 is a schematic cross-sectional view taken along line I-I′ of FIG. 1.

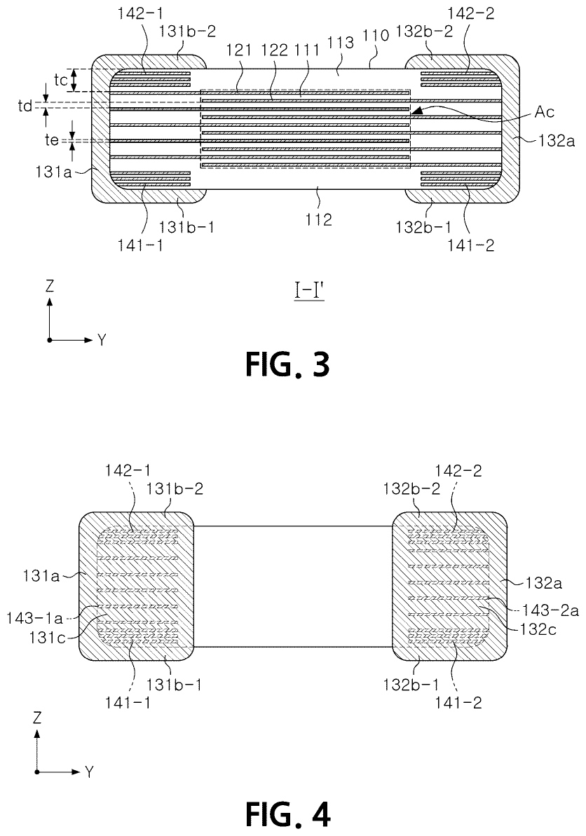

FIG. 3 is a schematic side view of a multilayer electronic component of FIG. 1 as viewed in an X-direction.

FIG. 4 is a schematic side view of a multilayer electronic component according to another exemplary embodiment of the present disclosure as viewed in an X-direction.

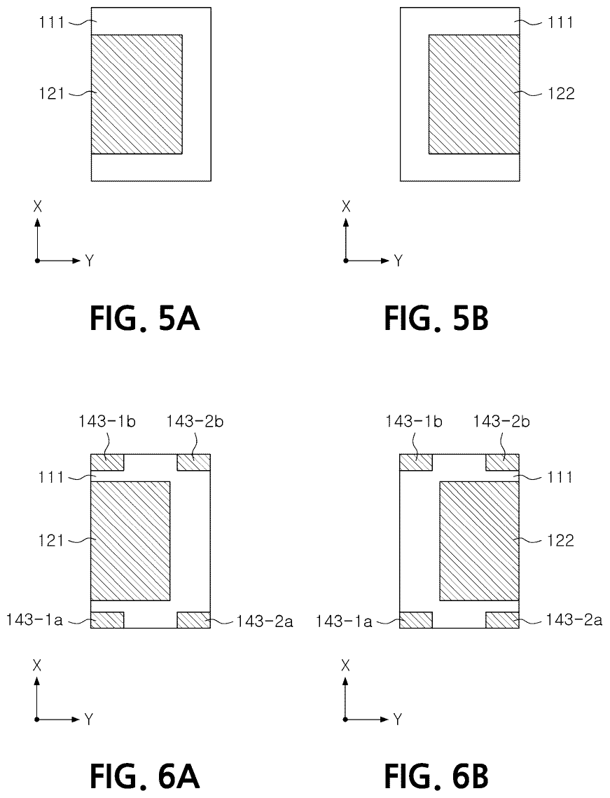

FIGS. 5A and 5B are schematic views of an internal electrode shape.

FIGS. 6A and 6B are schematic views of an internal electrode shape and a buffer electrode shape.

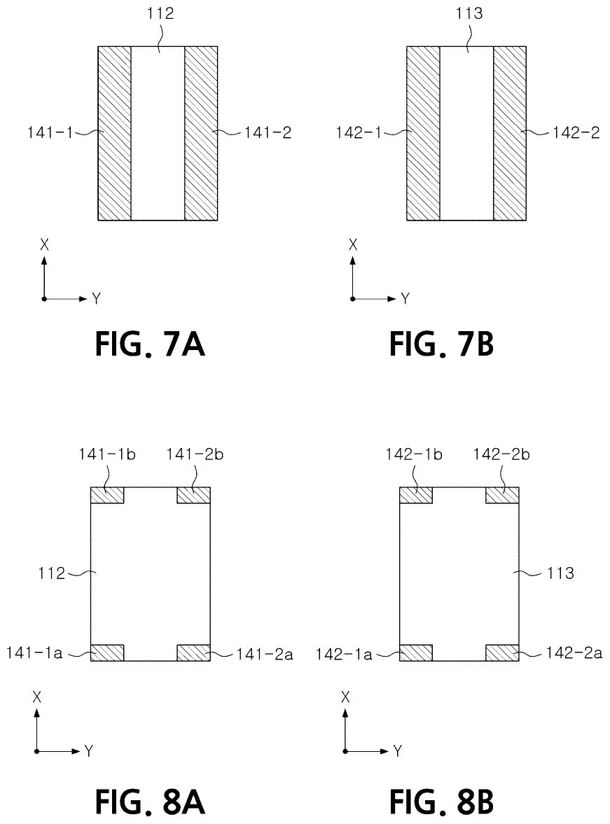

FIGS. 7A and 7B are schematic views of a dummy electrode shape of a cover portion.

FIGS. 8A and 8B are schematic views of another dummy electrode shape of a cover portion.

Hereinafter, a multilayer electronic component according to an exemplary embodiment of the present disclosure will be described in detail with reference to FIGS. 1 to 8B. An MLCC is described as an example of a multilayer electronic component. However, the present disclosure may be applied to various electronic products using a dielectric composition, such as inductors, piezoelectric elements, varistors, thermistors, or the like.

A multilayer electronic component 100 according to an exemplary embodiment of the present disclosure may include a body 110 including a capacitance formation portion including a dielectric layer 111 and internal electrodes 121 and 122 alternately disposed with the dielectric layer 111 in a thickness direction, and cover portions 112 and 113 disposed on the capacitance formation portion in the thickness direction, the body 110 including first and second surfaces 1 and 2 opposing each other in the thickness direction, third and fourth surfaces 3 and 4 connected to the first and second surfaces 1 and 2, the third and fourth surfaces 3 and 4 opposing each other in a length direction, and fifth and sixth surfaces 5 and 6 connected to the first to fourth surfaces 1, 2, 3 and 4, the fifth and sixth surfaces 5 and 6 opposing each other in a width direction, and external electrodes 131 and 132 including connection portions 131a and 132a disposed on the fifth and sixth surfaces 5 and 6, and band portions 131b and 132b disposed to extend from the connection portions 131a and 132a onto the first and second surfaces 1 and 2. The cover portions 112 and 113 may include at least one dummy electrode 141 or 142 exposed to at least one of the third and fourth surfaces 3 and 4. The external electrodes 131 and 132 may include side portions 131c and 132c extending from the band portions 131b and 132b onto at least one of the third and fourth surfaces 3 and 4, the side portions 131c and 132c disposed to cover the dummy electrodes 141 or 142 exposed to at least one of the third and fourth surfaces 3 and 4. A ratio (SBW/BW) of a size in the width direction (SBW) of each of the side portions 131c and 132c to a size in the width direction (BW) of each of the band portions 131b and 132b may satisfy 40%≤SBW/BW≤100%. A ratio (SBT/ET) of a size in the thickness direction (SBT) of each of the side portions 131c and 132c to a size in the thickness direction (ET) of each of the external electrodes 131 and 132 may satisfy 4%≤SBT/ET≤50%.

A multilayer electronic component 100 according to another exemplary embodiment of the present disclosure may include a body 110 including a capacitance formation portion including a dielectric layer 111 and internal electrodes 121 and 122 alternately disposed with the dielectric layer 111 in a thickness direction, and cover portions 112 and 113 disposed on the capacitance formation portion in the thickness direction, the body 110 having first and second surfaces 1 and 2 opposing each other in the thickness direction, third and fourth surfaces 3 and 4 connected to the first and second surfaces 1 and 2, the third and fourth surfaces 3 and 4 opposing each other in a length direction, and fifth and sixth surfaces 5 and 6 connected to the first to fourth surfaces 1, 2, 3 and 4, the fifth and sixth surfaces 5 and 6 opposing each other in a width direction, and external electrodes 131 and 132 including connection portions 131a and 132a disposed on the fifth and sixth surfaces 5 and 6, and band portions 131b and 132b disposed to extend from the connection portions 131a and 132a onto the first and second surfaces 1 and 2. The cover portions 112 and 113 may include at least one dummy electrode 141 or 142 exposed to at least one of the third and fourth surfaces 3 and 4. The external electrodes 131 and 132 may include side portions 131c and 132c extending from the band portions 131b and 132b onto at least one of the third and fourth surfaces 3 and 4, the side portions 131c and 132c disposed to cover the dummy electrode 141 or 142 exposed to at least one of the third and fourth surfaces 3 and 4. A ratio (SBW/BW) of a size in the width direction (SBW) of each of the side portions 131c and 132c to a size in the width direction (BW) of each of the band portions 131b and 132b may satisfy 46%≤SBW/BW 100%. A thickness (T) of the multilayer electronic component may satisfy 0.05 mm≤T≤0.3 mm.

A multilayer electronic component 100 according to another exemplary embodiment of the present disclosure may include a body 110 including a capacitance formation portion including a dielectric layer 111 and internal electrodes 121 and 122 alternately disposed with the dielectric layer 111 in a thickness direction, and cover portions 112 and 113 disposed on the capacitance formation portion in the thickness direction, the body 110 having first and second surfaces 1 and 2 opposing each other in the thickness direction, third and fourth surfaces 3 and 4 connected to the first and second surfaces 1 and 2, the third and fourth surfaces 3 and 4 opposing each other in a length direction, and fifth and sixth surfaces 5 and 6 connected to the first to fourth surfaces 1, 2, 3 and 4, the fifth and sixth surfaces 5 and 6 opposing each other in a width direction, and external electrodes 131 and 132 including connection portions 131a and 132a disposed on the fifth and sixth surfaces 5 and 6, and band portions 131b and 132b disposed to extend from the connection portions 131a and 132a onto the first and second surfaces 1 and 2. The cover portions 112 and 113 may include at least one dummy electrode 141 or 142 exposed to at least one of the third and fourth surfaces 3 and 4. The external electrodes 131 and 132 may include side portions 131c and 132c extending from the band portions 131b and 132b onto at least one of the third and fourth surfaces 3 and 4, the side portions 131c and 132c disposed to cover the dummy electrode 141 or 142 exposed to at least one of the third and fourth surfaces 3 and 4. A ratio (SBT/ET) of a size in the thickness direction (SBT) of each of the side portions 131c and 132c to a size in the thickness direction (ET) of each of the external electrodes 131 and 132 may satisfy 7%≤SBT/ET≤50%. A thickness (T) of the multilayer electronic component may satisfy 0.05 mm≤T≤0.3 mm.

In the body 110, the dielectric layer 111 and the internal electrodes 121 and 122 may be alternately laminated.

The body 110 may include a dielectric layer 111 and internal electrodes 121 and 122 disposed therein. More specifically, the body 110 may include a capacitance formation portion Ac in which the dielectric layer 111 and the internal electrodes 121 and 122 are alternately disposed with the dielectric layer 111 to form capacitance.

A specific shape of the body 110 is not limited. However, as illustrated, the body 110 may have a hexahedral shape or a shape similar thereto. During a sintering process, ceramic powder particles, included in the body 110, may shrink, such that the body 110 may not have a hexahedral shape having perfectly straight lines, but may have a substantially hexahedral shape.

The body 110 may have first and second surfaces 1 and 2 opposing each other in a thickness direction, third and fourth surfaces 3 and 4 connected to the first and second surfaces 1 and 2, the third and fourth surfaces 3 and 4 opposing each other in a length direction, and fifth and sixth surfaces 5 and 6 connected to the first to fourth surfaces 1, 2, 3, and 4, the fifth and sixth surfaces 5 and 6 opposing each other in a width direction.

A plurality of dielectric layers 111, included in the body 110, may be in a sintered state, and adjacent dielectric layers 111 may be integrated with each other such that boundaries therebetween are not readily apparent without using a scanning electron microscope (SEM).

A raw material included in the dielectric layer 111 is not limited as long as sufficient capacitance is obtainable therewith. In general, a perovskite (ABO₃)-based material may be used. For example, a barium titanate-based material, a lead composite perovskite-based material, or a strontium titanate-based material may be used. The barium titanate-based material may include BaTiO₃-based ceramic particles. Examples of the ceramic particles may include BaTiO₃, and (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y})O₃ (0<x<1, 0<y<1), or Ba (Ti_{1-y}Zr_{y})O₃ (0<y<1) obtained by partially dissolving Ca or Zr in BaTiO₃.

In addition, a raw material, included in the dielectric layer 111, may be obtained by adding various ceramic additives, organic solvents, binders, dispersants, or the like to particles such as barium titanate (BaTiO₃) depending on the purpose of the present disclosure.

In order to distinguish from a dielectric layer to be described below included in the cover portions 112 and 113, a dielectric layer included in the capacitance formation portion Ac may be defined as a first dielectric layer, and a dielectric layer included in the cover portions 112 and 113 may be defined as a second dielectric layer.

In addition, the first and second dielectric layers may be formed using a dielectric material such as barium titanate (BaTiO₃), and thus may include a dielectric microstructure after sintering. The dielectric microstructure may include a plurality of grains, a grain boundary disposed between adjacent grains, and a triple point disposed at a point with which three or more grain boundaries are in contact, and may include a plurality of grains, a plurality of grain boundaries, and a plurality of triple points.

A thickness (td) of the dielectric layer 111 is not limited.

In order to more easily achieve high capacitance and miniaturization of the multilayer electronic component, the thickness (td) of the dielectric layer 111 may be 1.0 μm or less, 0.8 μm or less, or 0.6 μm or less. In order to achieve ultra-miniaturization of the multilayer electronic component, the thickness (td) of the dielectric layer 111 may be 0.5 μm or less or 0.4 μm or less.

Here, the thickness (td) of the dielectric layer 111 may refer to a thickness (td) of the dielectric layer 111, disposed between the first and second internal electrode layers 121 and 122.

In this case, the thickness (td) of the dielectric layer 111 may be based on a concept including a thickness (td) of at least one of the plurality of dielectric layers 111, or may be based on a concept including thicknesses (td) of all the dielectric layers 111.

In addition, the thickness (td) of the dielectric layer 111 may refer to an average thickness (td) of a single dielectric layer 111, may refer to an average thickness (td) of each of the plurality of dielectric layers 111, or may refer to an average thickness (td) of the plurality of dielectric layers 111.

The average thickness (td) of the dielectric layer 111 may be measured by scanning, with an SEM, an image of a cross-section of the body 110 in the length and thickness directions at a magnification of 10,000. More specifically, the average thickness (td) of the single dielectric layer 111 may refer to an average value of thicknesses of the single dielectric layer 111, measured at five points spaced apart from each other at equal intervals in the length direction, in the scanned image. The five points, spaced apart from each other at equal intervals, may be designated in the capacitance formation portion Ac. In addition, when such average value measurement is performed on three dielectric layers 111, the average thickness (td) of the plurality of dielectric layers 111 may be further generalized.

The internal electrode layers 121 and 122 may be alternately laminated with the dielectric layer 111.

The internal electrode layers 121 and 122 may include a first internal electrode layer 121 and a second internal electrode layer 122, and the first and second internal electrode layers 121 and 122 may be alternately disposed with the dielectric layer 111, included in the body 110, interposed therebetween, and may be exposed through the fifth and sixth surfaces 5 and 6 of the body 110, respectively.

More specifically, the first internal electrode 121 may be spaced apart from the sixth surface 6, and may be exposed through the fifth surface 5 to be connected to the first external electrode 131, and the second internal electrode 122 may be spaced apart from the fourth surface 4, and may be exposed through the sixth surface 6 to be connected to the second external electrode 132.

That is, the first internal electrode 121 may not be connected to the second external electrode 132 and may be connected to the first external electrode 131, and the second internal electrode 122 may not be connected to the first external electrode 131 and may be connected to the second external electrode 132. In this case, the first and second internal electrodes 121 and 122 may be electrically isolated from each other by the dielectric layer 111 interposed therebetween.

In addition, the first internal electrode 121 and the second internal electrode 122 may preferably be spaced apart from the third and fourth surfaces 3 and 4 so as not to be exposed to the third and fourth surfaces 3 and 4, but the present disclosure is not limited thereto. The first internal electrode 121 and the second internal electrode 122 may be exposed to portions of the third and fourth surfaces 3 and 4. In addition, the first internal electrode 121, exposed to a portion of at least one of the third and fourth surfaces 3 and 4, may be disposed to be covered by the first external electrode 131, and the second internal electrode 122, exposed to a portion of at least one of the third and fourth surfaces 3 and 4, may be disposed to be covered by the second external electrode 132.

In the present disclosure, “disposed to cover” may mean that an element is disposed to entirely cover another element with no portion exposed externally.

The body 110 may be formed by alternately laminating a first ceramic green sheet on which a first internal electrode paste, used to form the first internal electrode 121, is printed and a second ceramic green sheet on which a second internal electrode paste, used to form the second internal electrode 122, is printed and then performing sintering thereon. A screen-printing method or a gravure-printing method may be used as a method of printing an internal electrode conductive paste, but the present disclosure is not limited thereto.

A material, included in the internal electrodes 121 and 122, is not limited, and a material having excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

A thickness (te) of each of the internal electrodes 121 and 122 is not limited. The thickness (te) of each of the internal electrodes 121 and 122 may refer to a thickness (te) of each of the first internal electrode 121 and the second internal electrode 122.

In order to achieve high capacitance and miniaturization of the multilayer electronic component, the thickness (te) of each of the internal electrodes 121 and 122 may be 1.0 μm or less, 0.8 μm or less, or 0.6 μm or less. In order to achieve ultra-miniaturization of the multilayer electronic component, the thickness (te) of each of the internal electrodes 121 and 122 may be 0.5 μm or less or 0.4 μm or less.

In this case, the thickness (te) of each of the internal electrodes 121 and 122 may be based on a concept including a thickness (te) of at least one of a plurality of internal electrodes 121 and a thickness (te) of at least one of a plurality of internal electrodes 122, or may be based on a concept including thicknesses (te) of all the internal electrodes 121 and 122.

In this case, the thickness (te) of each of the internal electrodes 121 and 122 may be based on a concept including a thickness (te) of at least one of the plurality of internal electrodes 121 and a thickness (te) of at least one of the plurality of internal electrodes 122, or may be based on a concept including thicknesses (te) of all the internal electrodes 121 and 122.

In addition, the thickness (te) of each of the internal electrodes 121 and 122 may refer to an average thickness (te) of a single internal electrode 121 and an average thickness (te) of a single internal electrode 122, may refer to an average thickness (te) of each of the plurality of internal electrodes 121 and an average thickness (te) of each of the plurality of internal electrodes 122, or may refer to an average thickness (te) of the plurality of internal electrodes 121 and an average thickness (te) of the plurality of internal electrodes 122.

The average thickness (te) of each of the internal electrodes 121 and 122 may be measured by scanning, with an SEM, an image of a cross-section of the body 110 in the length and thickness directions at a magnification of 10,000. More specifically, the average thickness (te) of the single internal electrode 121 and the average thickness (te) of the single internal electrode 122 may refer to an average value of thicknesses of the single internal electrode 121 and an average value of thicknesses of the single internal electrode 122, measured at five points spaced apart from each other at equal intervals in the length direction, in the scanned image. The five points, spaced apart from each other at equal intervals, may be designated in the capacitance formation portion Ac. In addition, when such average value measurement is performed on three internal electrodes 121 and 122, the average thicknesses (te) of the plurality of internal electrodes 121 and 122 may be further generalized.

The body 110 may include at least one buffer electrode 143 disposed to be spaced apart from the internal electrodes 121 and 122 in the length direction, the at least one buffer electrode 143 exposed to one of the third surface 3 and the fourth surface 4.

All the buffer electrodes 143, exposed to one of the third surface 3 and the fourth surface 4, may be disposed to be covered by the external electrodes 131 and 132, and more specifically, may be disposed to be covered by the side portions 131c and 132c to be described below.

The buffer electrode 143 may serve to improve bonding strength with the external electrodes 131 and 132, and may be disposed in a region in which the internal electrodes 121 and 122 are not disposed, and thus may serve to improve a step portion caused by repeated lamination of the dielectric layer 111 and the internal electrodes 121 and 122. In addition, the buffer electrode 143 may not contribute to forming capacitance.

The buffer electrode 143 may include a first buffer electrode 143-1 disposed to be close to the fifth surface 5, and a second buffer electrode 143-2 disposed to be close to the sixth surface 6.

Here, “disposed to be the fifth surface 5 or the sixth surface 6” may include a case in which an element is exposed to the fifth surface 5 or the sixth surface 6, and further may include a case in which an element is spaced apart from the fifth surface 5 or the sixth surface 6 without being exposed from the fifth surface 5 or the sixth surface 6, but is disposed to be closer than the sixth surface 6 or the fifth surface 5.

The first buffer electrode 143-1 may include a first-first buffer electrode 143-1a exposed to the third surface 3, the first-first buffer electrode 143-1a disposed to be covered by the first external electrode 131, and a first-second buffer electrode 143-1b exposed to the fourth surface 4, the first-second buffer electrode 143-1b disposed to be covered by the first external electrode 131. The second buffer electrode 143-2 may include a second-first buffer electrode 143-2a exposed to the third surface 3, the second-first buffer electrode 143-2a disposed to be covered by the second external electrode 132, and a second-second buffer electrode 143-2b exposed to the fourth surface 4, the second-second buffer electrode 143-2b disposed to be covered by the second external electrode 132.

In the present disclosure, descriptions of the buffer electrode 143 may correspond to descriptions of the first buffer electrode 143-1 and the second buffer electrode 143-2, respectively, and further may correspond to descriptions of the first-first and first-second buffer electrodes 143-1a and 143-1b, and the second-first and second-second buffer electrodes 143-2a and 143-2b, respectively.

In addition, the body 110 may include a plurality of buffer electrodes 143, spaced apart from each other in the thickness direction.

When a size in the width direction of the buffer electrode 143, exposed to one of the third surface 3 and the fourth surface 4, is referred to as BEW (not illustrated), a ratio (BEW/BW) of a size in the width direction (BEW) of the buffer electrode 143, exposed to one of the third surface 3 and the fourth surface 4, to a size in the width direction (BW) of each of the band portions 131b and 132b to be described below may satisfy 40%≤BEW/BW≤75%, and may preferably satisfy 46%≤BEW/BW≤75%.

The ratio of the size in the width direction (BEW) of the buffer electrode 143, exposed to one of the third surface 3 and the fourth surface 4, to the size in the width direction (BW) of each of the band portions 131b and 132b may satisfy 40%≤BEW/BW≤75%, such that a bonding area between the buffer electrode 143 and the external electrodes 131 and 132 may be increased, thereby improving bonding strength. As a result, delamination between the body 110 and the external electrodes 131 and 132 may be effectively prevented, and permeation of external moisture may be suppressed.

When the ratio of the size in the width direction (BEW) of the buffer electrode 143, exposed to one of the third surface 3 and the fourth surface 4, to the size in the width direction (BW) of each of the band portions 131b and 132b is less than 40%, the bonding area between the buffer electrode 143 and the external electrodes 131 and 132 may not be sufficient, such that bonding strength may not be improved. As a result, delamination may occur between the body 110 and the external electrodes 131 and 132. When the ratio (BEW/BW) of the size in the width direction (BEW) of the buffer electrode 143, exposed to one of the third surface 3 and the fourth surface 4, to the size in the width direction (BW) of each of the band portions 131b and 132b is greater than 75%, bonding strength between the buffer electrode 143 and the external electrodes 131 and 132 may be excellent. However, leakage current may occur due to permeation of external moisture, which may cause a decrease in insulation resistance (IR), degradation in the dielectric layer 111, reduction in dielectric constant, increase in equivalent series resistance (ESR), or a short-circuit of the internal electrodes 121 and 122.

The body 110 may include cover portions 112 and 113 disposed on both end surfaces in the thickness direction of the capacitance formation portion Ac.

Specifically, the body 110 may include a first cover portion 112 disposed on one surface in the thickness direction of the capacitance formation portion Ac, and a second cover portion 113 disposed on the other surface in the thickness direction of the capacitance formation portion Ac. More specifically, for example, the body 110 may include a first cover portion 112 disposed on a lower portion in the thickness direction of the capacitance formation portion Ac, and a second cover portion 113 disposed on an upper portion in the thickness direction of the capacitance formation portion Ac.

The first cover portion 112 and the second cover portion 113 may be formed by disposing or laminating a single second dielectric layer or two or more second dielectric layers on upper and lower surfaces of the capacitance formation portion Ac in the thickness direction, and may basically serve to prevent damage to the internal electrodes 121 and 122 due to physical or chemical stress.

The first cover portion 112 and the second cover portion 113 may not include the internal electrodes 121 and 122, and may include a dielectric material the same as that of the first dielectric layer 111 of the capacitance formation portion Ac. That is, the first cover portion 112 and the second cover portion 113 may include a dielectric material, and for example, may include a barium titanate (BaTiO₃)-based dielectric material.

The cover portions 112 and 113 may include at least one dummy electrode 141 or 142 exposed to at least one of the third surface 3 and the fourth surface 4.

All the dummy electrodes 141 and 142, exposed to one of the third surface 3 and the fourth surface 4, may be disposed to be covered by the external electrodes 131 and 132, and more specifically, may be disposed to be covered by the side portions 131c and 132c to be described below.

The dummy electrodes 141 and 142 may correspond to electrodes not contributing to forming capacitance. In addition, the dummy electrodes 141 and 142 may serve to improve bonding strength with the external electrodes 131 and 132, may be disposed in a region in which the internal electrodes 121 and 122 are not disposed, and thus may serve to improve a step portion caused by repeated lamination of the dielectric layer 111 and the internal electrodes 121 and 122. In addition, the dummy electrodes 141 and 142 may serve to improve bending strength of the multilayer electronic component 100.

The dummy electrodes 141 and 142 may be disposed to be close to the fifth surface 5 or the sixth surface 6.

Here, “disposed to be close to the fifth surface 5 or the sixth surface 6” may include a case in which an element is exposed to the fifth surface 5 or the sixth surface 6, and further may include a case in which an element is spaced apart from the fifth surface 5 or the sixth surface 6 without being exposed from the fifth surface 5 or the sixth surface 6, but is disposed to be closer than the sixth surface 6 or the fifth surface 5.

More specifically, the first cover portion 112 may include a first dummy electrode 141 exposed to at least one of the third surface 3 and the fourth surface 4, and the second cover portion 113 may include a second dummy electrode 142 exposed to at least one of the third surface 3 and the fourth surface 4.

The first dummy electrode 141 may include at least one of a first-first dummy electrode 141-1 disposed to be close to the fifth surface 5, the first-first dummy electrode 141-1 exposed to both the third surface 3 and the fourth surface 4, and a first-second dummy electrode 141-2 disposed to be close to the sixth surface 6, the first-second dummy electrode 141-2 exposed to both the third surface 3 and the fourth surface 4, but the present disclosure is not limited thereto. The first dummy electrode 141 may include at least one of a first-first-first dummy electrode 141-1a disposed to be close to the fifth surface 5, the first-first-first dummy electrode 141-1a exposed to the third surface 3 but not exposed to the fourth surface 4, a first-first-second dummy electrode 141-1b disposed to be close to the fifth surface 5, the first-first-second dummy electrode 141-1b exposed to the fourth surface 4 but not exposed to the third surface 3, a first-second-first dummy electrode 141-2a disposed to be close to the sixth surface 6, the first-second-first dummy electrode 141-2a exposed to the third surface 3 but not exposed to the fourth surface 4, and a first-second-second dummy electrode 141-2b disposed to be close to the sixth surface 6, the first-second-second dummy electrode 141-2b exposed to the fourth surface 4 but not exposed to the third surface 3.

The second dummy electrode 142 may include at least one of a second-first dummy electrode 142-1 disposed to be close to the fifth surface 5, the second-first dummy electrode 142-1 exposed to both the third surface 3 and the fourth surface 4, and a second-second dummy electrode 142-2 disposed to be close to the sixth surface 6, the second-second dummy electrode 142-2 exposed to both the third surface 3 and the fourth surface 4, but the present disclosure is not limited thereto. The second dummy electrode 142 may include at least one of a second-first-first dummy electrode 142-1a disposed to be close to the fifth surface 5, the second-first-first dummy electrode 142-1a exposed to the third surface 3 but not exposed to the fourth surface 4, a second-first-second dummy electrode 142-1b disposed to be close to the fifth surface 5, the second-first-second dummy electrode 142-1b exposed to the fourth surface 4 but not exposed to the third surface 3, a second-second-first dummy electrode 142-2a disposed to be close to the sixth surface 6, the second-second-first dummy electrode 142-2a exposed to the third surface 3 but not exposed to the fourth surface 4, and a second-second-second dummy electrode 142-2b disposed to be close to the sixth surface 6, the second-second-second dummy electrode 142-2b exposed to the fourth surface 4 but not exposed to the third surface 3.

In the present disclosure, descriptions of the dummy electrodes 141 and 142 may correspond to descriptions of the first dummy electrode 141 and the second dummy electrode 142, respectively, and further may correspond to descriptions of the first-first dummy electrode 141-1, the first-second dummy electrode 141-2, the second-first dummy electrode 142-1, and the second-second dummy electrode 142-2, respectively, and even further may correspond to descriptions of the first-first-first dummy electrode 141-1a, the first-first-second dummy electrode 141-1b, the first-second-first dummy electrode 141-2a, the first-second-second dummy electrode 141-2b, the second-first-first dummy electrode 142-1a, the second-first-second dummy electrode 142-1b, the second-second-first dummy electrode 142-2a, and the second-second-second dummy electrode 142-2b, respectively.

In addition, the cover portions 112 and 113 may include a plurality of dummy electrodes 141 and 142, spaced apart from each other in the thickness direction.

A ratio (DEW/BW) of a size in the width direction (DEW) of each of the dummy electrodes 141 and 142, exposed in the length direction, of the cover portions 112 and 113 to the size in the width direction (BW) of each of the band portions 131b and 132b to be described below may satisfy 40%≤DEW/BW≤75%, and may preferably satisfy 46%≤DEW/BW≤75%.

The ratio (DEW/BW) of the size in the width direction (DEW) of each of the dummy electrodes 141 and 142, exposed in the length direction, of the cover portions 112 and 113 to the size in the width direction (BW) of each of the band portions 131b and 132b may satisfy 40%≤DEW/BW≤75%, such that a bonding area between the dummy electrodes 141 and 142 and the external electrodes 131 and 132 may be increased, thereby improving bonding strength. As a result, delamination between the body 110 and the external electrodes 131 and 132 may be effectively prevented, and permeation of external moisture may be suppressed.

When a ratio (DEW/BW) of a size in the width direction (DEW) of each of the dummy electrodes 141 and 142, exposed to one of the third surface 3 and the fourth surface 4, to the size in the width direction (BW) of each of the band portions 131b and 132b is less than 40%, the bonding area between the dummy electrodes 141 and 142 and the external electrodes 131 and 132 may not be sufficient, such that bonding strength may not be improved. As a result, delamination may occur between the body 110 and the external electrodes 131 and 132. When the ratio (DEW/BW) of the size in the width direction (DEW) of each of the dummy electrodes 141 and 142, exposed to one of the third surface 3 and the fourth surface 4, to the size in the width direction (BW) of each of the band portions 131b and 132b is greater than 75%, the bonding strength between the dummy electrodes 141 and 142 and the external electrodes 131 and 132 may be excellent. However, leakage current may occur due to permeation of external moisture, which may cause a decrease in IR, degradation of the dielectric layer 111, reduction in dielectric constant, increase in ESR, or a short-circuit of the internal electrodes 121 and 122.

The size in the width direction (DEW) of each of the dummy electrodes 141 and 142, exposed in the length direction, of the cover portions 112 and 113 may be 20 μm or more, and may be equal to or less than a size in the width direction (SBW) of a side portion to be described below. That is, the size in the width direction (DEW) of each of the dummy electrodes 141 and 142, exposed in the length direction, of the cover portions 112 and 113 may satisfy 20 μm≤DEW≤SBW.

The size in the width direction (DEW) of each of the dummy electrodes 141 and 142, exposed in the length direction, of the cover portions 112 and 113 may satisfy 20 μm≤DEW≤SBW, such that the bonding area between the dummy electrodes 141 and 142 and the external electrodes 131 and 132 may be increased, thereby improving bonding strength. As a result, delamination between the body 110 and the external electrodes 131 and 132 may be effectively prevented, and permeation of external moisture may be suppressed.

When the size in the width direction (DEW) of each of the dummy electrodes 141 and 142, exposed in the length direction, of the cover portions 112 and 113 is less than 20 μm, the bonding area between the dummy electrodes 141 and 142 and the external electrodes 131 and 132 may not be sufficient, such that bonding strength may not be improved. When the size in the width direction (DEW) of each of the dummy electrodes 141 and 142, exposed in the length direction, of the cover portions 112 and 113 is greater than the size in the width direction (SBW) of the side portion, the dummy electrodes 141 and 142 may be exposed externally, such that leakage current may occur, which may cause a decrease in IR, degradation of the dielectric layer 111, reduction in dielectric constant, increase in ESR, or short-circuit between the internal electrodes 121 and 122.

A method of measuring the size in the width direction (DEW) of each of the dummy electrodes 141 and 142, exposed in the length direction, of the cover portions 112 and 113 may include polishing an end surface in the thickness and width directions of the multilayer electronic component 100 to remove the side portions 131c and 132c, and then measuring the size in the width direction (DEW) of each of the dummy electrodes 141 and 142, exposed in the length direction, of the cover portions 112 and 113, but the present disclosure is not limited thereto.

A method of measuring the size in the width direction (BW) of each of the band portions 131b and 132b will be described below.

A thickness (tc) of each of the cover portions 112 and 113 is not limited. Hereinafter, the thickness (tc) of each of the cover portions 112 and 113 may refer to a thickness (tc) of each of the first cover portion 112 and the second cover portion 113.

However, in order to more easily achieve miniaturization and high capacitance of the multilayer electronic component 100, the thickness (tc) of each of the cover portions 112 and 113 may be 100 μm or less or 50 μm or less, may be preferably 30 μm or less, and may be more preferably 20 μm or less in ultrasmall products.

Here, the thickness (tc) of each of the cover portions 112 and 113 may refer to an average thickness of each of the cover portions 112 and 113.

In addition, the average thickness (tc) of each of the cover portions 112 and 113 may refer to an average thickness (tc) of each of the first cover portion 112 and the second cover portion 113, or may refer to an average thickness (tc) of the first cover portions 112 and an average thickness (tc) of the second cover portions 113.

The average thickness (tc) of each of the cover portions 112 and 113 may be measured by scanning, with an SEM, an image of a cross-section of the body 110 in the length and thickness directions at a magnification of 10,000. More specifically, an average thickness (te) of a single cover portion 112 and an average thickness (te) of a single cover portion 113 may refer to an average value of thicknesses of the single cover portion 112 and an average value of thicknesses of the single cover portion 113, measured at five points spaced apart from each other at equal intervals in the length direction, in the scanned image.

In addition, the average thickness (tc) of each of the cover portions 112 and 113, measured using the above-described method, may have a value substantially equal to that of an average thickness of each of the cover portions 112 and 113 in a cross-section of the body 110 in the width and thickness directions.

In an exemplary embodiment of the present disclosure, a structure in which the multilayer electronic component 100 includes two external electrodes 131 and 132 is described, but the number, shape, or the like of the external electrodes 131 and 132 may be changed depending on a form of the internal electrodes 121 and 122 or other purposes.

The external electrodes 131 and 132 may be disposed on the body 110, and may be connected to the internal electrodes 121 and 122.

More specifically, the external electrodes 131 and 132 may be disposed on the fifth surface 5 and the sixth surface 6 of the body 110, respectively, and may include first and second external electrodes 131 and 132, respectively connected to the first and second internal electrodes 121 and 122. That is, the first external electrode 131 may be disposed on the fifth surface 5 of the body 110, and may be connected to the first internal electrode 121, and the second external electrode 132 may be disposed on the sixth surface 6 of the body 110, and may be connected to the second internal electrode 122.

In addition, the external electrodes 131 and 132 may be disposed to extend from the fifth and sixth surfaces 5 and 6 of the body 110 to a portion of first and second surfaces 1 and 2 of the body 110, respectively, or may be disposed to extend from the fifth and sixth surfaces 5 and 6 of the body 110 to a portion of third and fourth surfaces 3 and 4, respectively. That is, the first external electrode 131 may be disposed on the fifth surface 5 of the body 110 and on a portion of the first to fourth surfaces 1, 2, 3, and 4 of the body 110, and the second external electrode 132 may be disposed on the sixth surface 6 of the body 110 and on a portion of the first to fourth surfaces 1, 2, 3, and 4 of the body 110.

More specifically, the external electrodes 131 and 132 may include connection portions 131a and 132a disposed on the fifth and sixth surfaces 5 and 6 of the body 110, band portions 131b and 132b disposed to extend from the connection portions 131a and 132a to a portion of the first and second surfaces 1 and 2 of the body 110, and side portions 131c and 132c disposed to extend from the band portions 131b and 132b to a portion of the third and fourth surfaces 3 and 4 of the body 110.

In some drawings, only the side portions 131c and 132c disposed on the third and fourth surfaces 3 and 4 of the body 110 to extend in the thickness direction from the band portions 131b and 132b are illustrated, but the present disclosure is not limited thereto. The external electrodes 131 and 132 may be disposed on the third and fourth surfaces 3 and 4 of the body 110 to extend in the width direction from the connection portions 131a and 132a. In this case, the external electrodes 131 and 132, disposed on the third and fourth surfaces 3 and 4, may include the side portions 131c and 132c, and thus may have a bracket shape (a C-shape) or a horseshoe shape (a U-shape), and further may have a shape as illustrated in FIG. 4.

More specifically, the first external electrode 131 may include a first connection portion 131a disposed on the fifth surface 5 of the body 110, a first band portion 131b extending from the first connection portion 131a to at least a portion of the first and second surfaces 1 and 2, and a first side portion 131c extending from the first band portion 131b to at least a portion of the third and fourth surfaces 3 and 4. The second external electrode 132 may include a second connection portion 132a disposed on the sixth surface 6 of the body 110, a second band portion 132b extending from the second connection portion 132a to at least a portion of the first and second surfaces 1 and 2, and a second side portion 132c extending from the second band portion 132b to at least a portion of the third and fourth surfaces 3 and 4.

The first band portion 131b may include a first-first band portion 131b-1 extending from the first connection portion 131a to a portion of the first surface 1, and a first-second band portion 131b-2 extending from the first connection portion 131a to a portion of the second surface 2. The second band portion 132b may include a second-first band portion 132b-1 extending from the second connection portion 132a to a portion of the first surface 1, and a second-second band portion 132b-2 extending from the second connection portion 132a to a portion of the second surface 2.

The first side portion 131c may include at least one of a first-first side portion 131c disposed to extend from the first band portion 131b to at least a portion of the third surface 3, and a first-second side portion disposed to extend from the first band portion 131b to at least a portion of the fourth surface 4. The second side portion 132c may include at least one of a second-first side portion 132c disposed to extend from the second band portion 132b to at least a portion of the third surface 3, and a second-second side portion disposed to extend from the second band portion 132b to at least a portion of the fourth surface 4.

In the present disclosure and drawings, the first-first side portion 131c and the second-first side portion 132c, disposed on the third surface 3, are mainly described and illustrated. However, the first-second side portion and/or the second-second side portion, disposed on the fourth surface 4, could also be readily understood by those skilled in the art.

The first-first side portion 131c may include a first-first-first side portion 131c-1 disposed to extend from the first-first band portion 131b-1 to at least a portion of the third surface 3, and a first-first-second side portion 131c-2 disposed to extend from the first-second band portion 131b-2 to at least a portion of the third surface 3. However, when the first-first-first side portion 131c-1 and the first-first-second side portion 131c-2 are disposed to further extend toward each other and come into contact with each other, the first-first side portion 131c may be formed as a single side portion.

The second-first side portion 132c may include a second-first-first side portion 132c-1 disposed to extend from the second-first band portion 132b-1 to at least a portion of the third surface 3, and a second-first-second side portion 132c-2 disposed to extend from the second-second band portion 132b-2 to at least a portion of the third surface 3. However, when the second-first-first side portion 132c-1 and the second-first-second side portion 132c-2 are disposed to further extend toward each other and come into contact with each other, the second-first side portion 132c may be formed as a single side portion.

In the present disclosure, unless particularly inconsistent, descriptions of the band portions 131b and 132b may correspond to descriptions of the first band portion 131b and the second band portion 132b, respectively, and further may correspond to descriptions of the first-first band portion 131b-1, the first-second band portion 131b-2, the second-first band portion 132b-1, and the second-second band portion 132b-2, respectively. In addition, descriptions of the side portions 131c and 132c may correspond to descriptions of the first side portion 131c and the second side portion 132c, respectively, and further may correspond to descriptions of the first-first side portion 131c, the first-second side portion, the second-first side portion 132c, and the second-second side portion, respectively, and even further may correspond to descriptions of the first-first-first side portion 131c-1, the first-first-second side portion 131c-2, the second-first-first side portion 132c-1, and the second-first-second side portion 132c-2, respectively.

The side portions 131c and 132c may be disposed to cover the dummy electrodes 141 and 142 exposed to at least one of the third and fourth surfaces 3 and 4.

In addition, when the body 110 further includes a buffer electrode 143 exposed to at least one of the third and fourth surfaces 3 and 4, the side portions 131c and 132c may be disposed to cover the buffer electrode 143 exposed to at least one of the third and fourth surfaces 3 and 4.

The side portions 131c and 132c may be disposed to cover the dummy electrodes 141 and 142 or the buffer electrode 143 exposed to at least one of the third and fourth surfaces 3 and 4, such that a bonding area between the body 110 and the external electrodes 131 and 132 may be increased, thereby improving bonding strength. As a result, delamination between the body 110 and the external electrodes 131 and 132 may be effectively prevented, and permeation of external moisture may be suppressed.

A ratio (SBW/BW) of a size in the width direction (SBW) of each of the side portions 131c and 132c to a size in the width direction (BW) of each of the band portions 131b and 132b may satisfy 40%≤SBW/BW≤100%, and may preferably satisfy 46%≤SBW/BW≤100%, and may more preferably satisfy 46%≤SBW/BW≤75%.

The ratio (SBW/BW) of the size in the width direction (SBW) of each of the side portions 131c and 132c to the size in the width direction (BW) of each of the band portions 131b and 132b may satisfy 40%≤SBW/BW≤100%, thereby improving bonding strength. As a result, delamination between the body 110 and the external electrodes 131 and 132 may be effectively prevented.

When the ratio (SBW/BW) of the size in the width direction (SBW) of each of the side portions 131c and 132c to the size in the width direction (BW) of each of the band portions 131b and 132b is less than 40%, the bonding area between the body 110 and the external electrodes 131 and 132 may not be sufficient, such that bonding strength may not be improved.

When the ratio (SBW/BW) of the size in the width direction (SBW) of each of the side portions 131c and 132c to the size in the width direction (BW) of each of the band portions 131b and 132b is greater than 100%, bonding strength between the body 110 and the external electrodes 131 and 132 may be excellent. However, a voltage disposed in an adjacent position may be connected to other external electrodes, resulting in occurrence of a short-circuit.

A method of measuring the size in the width direction (BW) of each of the band portions 131b and 132b may include polishing an end surface in the thickness and width directions of the multilayer electronic component 100 to remove the side portions 131c and 132c, and measuring a size in the width direction of each of the band portions 131b and 132b from the fifth surface 5 or the sixth surface 6 at at least three points (at regular intervals in the thickness direction), and then averaging the measured values. Alternatively, the size in the width direction (BW) of each of the band portions 131b and 132b may be obtained by measuring the size in the width direction of each of the band portions 131b and 132b from the fifth surface 5 or the sixth surface 6 at at least three points (at regular intervals in the thickness direction), based on a cross-section in the thickness and width directions of the multilayer electronic component 100. However, the present disclosure is not limited thereto.

A method of measuring the size in the width direction (SBW) of each of the side portions 131c and 132c may include measuring a size in the width direction of each of the side portions 131c and 132c from the fifth surface 5 or the sixth surface 6 at at least three points (at regular intervals in the thickness direction), based on an end surface in the thickness and width directions of the multilayer electronic component 100. When the side portions 131c and 132c are formed as a single portion as illustrated in FIG. 4, the size in the width direction (SBW) of each of the side portions 131c and 132c may be obtained by measuring a size in the width direction of each of the external electrodes 131 and 132, polishing an end surface in the thickness and width directions of the multilayer electronic component 100 to remove the side portions 131c and 132c, and measuring a size in the width direction of each of the side portions 131c and 132c from the fifth surface 5 or the sixth surface 6 at at least three points (at regular intervals in the thickness direction). Alternatively, the size in the width direction (SBW) of each of the side portions 131c and 132c may be obtained by measuring the size in the width direction of each of the side portions 131c and 132c from the fifth surface 5 or the sixth surface 6 at at least three points (at regular intervals in the thickness direction), based on a cross-section in the thickness and width directions of the multilayer electronic component 100. However, the present disclosure is not limited thereto.

A ratio (SBT/ET) of a size in the thickness direction (SBT) of each of the side portions 131c and 132c to a size in the thickness direction (ET) of each of the external electrodes 131 and 132 may satisfy 4%≤SBT/ET≤50%, and may preferably satisfy 7%≤SBT/ET≤50%.

The ratio (SBT/ET) of the size in the thickness direction (SBT) of each of the side portions 131c and 132c to the size in the thickness direction (ET) of each of the external electrodes 131 and 132 may satisfy 4% SBT/ET 50%, such that a bonding area between the body 110 and the external electrodes 131 and 132 may be increased, thereby improving bonding strength. As a result, delamination between the body 110 and the external electrodes 131 and 132 may be effectively prevented.

In this case, when the ratio (SBT/ET) of the size in the thickness direction (SBT) of each of the side portions 131c and 132c to the size in the thickness direction (ET) of each of the external electrodes 131 and 132 is 50%, the first side portion 131c-1 may be formed as a single side portion, for example.

When the ratio (SBT/ET) of the size in the thickness direction (SBT) of each of the side portions 131c and 132c to the size in the thickness direction (ET) of each of the external electrodes 131 and 132 is less than 4%, the bonding area between the body 110 and the external electrodes 131 and 132 may be insufficient, such that bonding strength may not be improved.

The external electrodes 131 and 132 may be formed using any material having electrical conductivity, such as a metal or the like, and a specific material may be determined in consideration of electrical properties, structural stability, and the like. In addition, the external electrodes 131 and 132 may have a multilayer structure.

For example, the external electrodes 131 and 132 may include a first electrode layer disposed on the body 110, and a second electrode layer disposed on the first electrode layer. The first and second electrode layers may include metal materials included in a plurality of different regions.

Here, the first and second electrode layers preferably correspond to mutually distinct layers. However, the present disclosure is not limited thereto. The classification into the first and second electrode layers may merely reflect the order of manufacturing processes. The first and second electrode layers may not be distinguishable from each other, and may be observed as a single layer.

In the present disclosure, the term “distinct” may refer to two layers being distinguishable due to a physical difference, a chemical difference, and/or a simple optical difference. The present disclosure is not limited thereto. However, the distinction between layers may be determined based on the presence or absence of an “interface.” The interface may refer to a surface at which two layers in contact with each other are distinguishable, and, for example, may refer to a surface at which the two layers are distinguishable due to a compositional difference observed through EDS analysis using equipment such as an SEM.

The first electrode layer may be formed by transferring a sheet including a conductive metal onto the body 110, or by coating an external electrode conductive paste including a conductive metal on the body 110 and then sintering the external electrode conductive paste. Alternatively, the first electrode layer may be formed by a dipping method in which the body 110 is immersed in the external electrode conductive paste including a conductive metal. However, the present disclosure is not limited thereto.

As a more specific example of the first electrode layer, the first electrode layer may be a sintered electrode including a conductive metal and glass.

As the conductive metal included in the first electrode layer, a material having excellent electrical conductivity may be used. For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof, but the present disclosure is not limited thereto.

In addition, the glass included in the first electrode layer may serve to improve adhesion to the body 110.

When a case in which the first electrode layer includes metal materials included in a plurality of different regions is used as an example, a first sintered electrode region including copper (Cu) as a main element may be disposed on the fifth and sixth surfaces 5 and 6 of the body 110, a second sintered electrode region including nickel (Ni) as a main element may be disposed on the first and second surfaces 1 and 2, and a plating layer region including nickel (Ni) and/or tin (Sn) as main elements may be disposed on the third and fourth surfaces 3 and 4. That is, the first electrode layer in contact with the body 110 may include the first sintered electrode region, the second sintered electrode region, and the plating layer region, and the second electrode layer may be disposed on the first electrode layer.

The second electrode layer may serve to improve mounting properties, and may be a plating layer formed on the first electrode layer using a plating method, but the present disclosure is not limited thereto.

A type of the second electrode layer is not limited. For example, the second electrode layer may include at least one of nickel (Ni), tin (Sn), silver (Ag), palladium (Pd), and alloys thereof.

The second electrode layer may be a single layer or a plurality of layers.

More specifically, for example, the second electrode layer may be a nickel (Ni) electrode layer or a tin (Sn) electrode layer, and may have a form in which a nickel (Ni) electrode layer and a tin (Sn) electrode layer are sequentially formed on the first electrode layer, or a form in which a tin (Sn) electrode layer, a nickel (Ni) electrode layer, and a tin (Sn) electrode layer are sequentially formed on the first electrode layer. In addition, the second electrode layer may include a plurality of nickel (Ni) electrode layers and/or a plurality of tin (Sn) electrode layers.

A size of the multilayer electronic component 100 is not limited.

However, in order to reduce equivalent series inductance (ESL), the external electrodes 131 and 132 may be disposed on the body 110 in the width direction, and the body 110 and/or the multilayer electronic component 100 may have a length greater than a width.

In addition, for high-speed signal processing and applications in high-frequency regions, a thickness (T) of the (ultra)small-sized multilayer electronic component 100 may be 0.05 mm or more and 0.3 mm or less, a length (L) of the (ultra)small-sized multilayer electronic component 100 may be 0.25 mm or more, and a width (W) of the (ultra) small-sized multilayer electronic component 100 may be 0.5 mm or more.

Hereinafter, the present disclosure will be described in further detail through experimental examples, which are provided to facilitate a specific understanding of the present disclosure and are not intended to limit the scope of the present disclosure.

### Experimental Examples

[Table 1] indicates evaluation results of whether delamination of an external electrode occurred, according to a ratio (SBW/BW) of a size in a width direction (SBW) of a side portion to a size in the width direction (BW) of a band portion, and/or a ratio (SBT/ET) of a size in a thickness direction (SBT) of the side portion to a size in the thickness direction (ET) of the external electrode.

A sample chip was manufactured to satisfy a thickness of 0.085 mm or more and 0.095 mm or less, a length of 0.50 mm or more and 0.55 mm or less, and a width of 1.00 mm or more and 1.02 mm or less. An external electrode was manufactured to include a connection portion, a band portion, and a side portion, and was designed to be as symmetrical as possible.

For each test example, 100 sample chips were prepared, and the test examples were divided into groups A to E according to the ratio (SBW/BW) of the size in the width direction (SBW) of the side portion to the size in the width direction (BW) of the band portion. Test examples A to E were further divided into 5 groups (Test Examples 1 to 5) according to the ratio (SBT/ET) of the size in the thickness direction (SBT) of the side portion to the size in the thickness direction (ET) of the external electrode. For example, the number of defective sample chips in Test Example A-1 is 2 out of 100.

As an evaluation method for external electrode delamination, a tape test method was used. In the tape test method, a tape having the same adhesive strength was attached to an external electrode of each sample chip, and the tape was peeled off at an angle of 30° at a constant speed. In this case, when delamination of the external electrode occurred, a sample chip was evaluated as a defective sample chip, and when delamination did not occur, the sample chip was evaluated as a non-defective sample chip. [Table 1] indicates the number of defective sample chips out of 100 sample chips for each test example.

TABLE 1

| | | | SBT/ET (%) | | | | |
|---|---|---|---|---|---|---|---|
| | | | Test | Test | Test | Test | Test |
| | | | Example 1 | Example 2 | Example 3 | Example 4 | Example 5 |
| Samples | | | 2% | 4% | 7% | 12% | 50% |
| SBW/BW | Test | 28% | 2/100 | 1/100 | 0/100 | 0/100 | 0/100 |
| (%) | Example A | | | | | | |
| | Test | 40% | 4/100 | 0/100 | 0/100 | 0/100 | 0/100 |
| | Example B | | | | | | |
| | Test | 46% | 0/100 | 0/100 | 0/100 | 0/100 | 0/100 |
| | Example C | | | | | | |
| | Test | 58% | 0/100 | 0/100 | 0/100 | 0/100 | 0/100 |
| | Example D | | | | | | |
| | Test | 75% | 0/100 | 0/100 | 0/100 | 0/100 | 0/100 |
| | Example E | | | | | | |

When an SBW/BW value was 460 or more and 750 or less, there were no defective sample chips in which the external electrode was delaminated, regardless of the SBT/ET value. When the SBT/ET value was 70 or more and 500 or less, there were no defective sample chips in which the external electrode was delaminated, regardless of the SBW/BW value.

In a case in which the SBW/BW value was 400, when the SBT/ET value was 20, there were 4 defective sample chips out of 100 in which the external electrode was delaminated, However, when the SBT/ET value was 40 or more and 500 or less, there were no defective sample chips in which the external electrode was delaminated.

In a case in which the SBT/ET value was 4%, when the SBW/BW value was 28%, there was 1 defective sample chip out of 100 in which the external electrode was delaminated. However, when the SBW/BW value was 40% or more, there were no defective sample chips in which the external electrode was delaminated.

From the above results, it can be seen that, when the SBW/BW value is 46% or more and 75% or less, when the SBT/ET value is 7% or more and 50% or less, or when the SBW/BW value is 40% or more and the SBT/ET value is 4% or more, bonding strength between a body and the external electrode is excellent.

While example embodiments have been shown and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

The terms used herein is for the purpose of describing particular example embodiments only and is not to be limiting of the example embodiments. As used herein, the singular forms “a,” “an,” and “the” are intended to include the plural forms as well, unless the context clearly indicates otherwise.

What is claimed is:

1. A multilayer electronic component comprising:
a body including a capacitance formation portion including a dielectric layer and an internal electrode alternately disposed with the dielectric layer in a thickness direction, and a cover portion disposed on the capacitance formation portion in the thickness direction, the body having first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction;
an external electrode including a connection portion disposed on the fifth and sixth surfaces, and a band portion disposed to extend from the connection portion onto the first and second surfaces,
wherein the cover portion includes at least one dummy electrode exposed to at least one of the third and fourth surfaces,
the external electrode includes a side portion extending from the band portion onto at least one of the third and fourth surfaces, the side portion disposed to cover the dummy electrode exposed to at least one of the third and fourth surfaces,
a ratio (SBW/BW) of a size in the width direction (SBW) of the side portion to a size in the width direction (BW) of the band portion satisfies 40%≤SBW/BW≤100%, and
a ratio (SBT/ET) of a size in the thickness direction (SBT) of the side portion to a size in the thickness direction (ET) of the external electrode satisfies 4%≤SBT/ET≤50%.

2. The multilayer electronic component of claim 1, wherein a ratio (DEW/BW) of a size in the width direction (DEW) of the dummy electrode, exposed in the length direction, of the cover portion to the size in the width direction (BW) of the band portion satisfies 40%≤DEW/BW≤75%.

3. The multilayer electronic component of claim 2, wherein the DEW and the SBW satisfy 20 μm≤DEW≤SBW.

4. The multilayer electronic component of claim 1, wherein
the body further includes at least one buffer electrode disposed to be spaced apart from the internal electrode in the length direction, the at least one buffer electrode exposed to one of the third and fourth surfaces, and
the side portion is disposed to cover the buffer electrode exposed to one of the third and fourth surfaces.

5. The multilayer electronic component of claim 1, wherein the multilayer electronic component has a length greater than a width.

6. The multilayer electronic component of claim 1, wherein a thickness (T) of the multilayer electronic component satisfies 0.05 mm≤T≤0.3 mm.

7. A multilayer electronic component comprising:
a body including a capacitance formation portion including a dielectric layer and an internal electrode alternately disposed with the dielectric layer in a thickness direction, and a cover portion disposed on the capacitance formation portion in the thickness direction, the body having first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction; and
an external electrode including a connection portion disposed on the fifth and sixth surfaces, and a band portion disposed to extend from the connection portion onto the first and second surfaces,
wherein the cover portion includes at least one dummy electrode exposed to at least one of the third and fourth surfaces,
the external electrode includes a side portion extending from the band portion onto at least one of the third and fourth surfaces, the side portion disposed to cover the dummy electrode exposed to at least one of the third and fourth surfaces,
a ratio (SBW/BW) of a size in the width direction (SBW) of the side portion to a size in the width direction (BW) of the band portion satisfies 46%≤SBW/BW≤100%, and
a thickness (T) of the multilayer electronic component satisfies 0.05 mm≤T≤0.3 mm.

8. The multilayer electronic component of claim 7, wherein a ratio (SBT/ET) of a size in the thickness direction (SBT) of the side portion to a size in the thickness direction (ET) of the external electrode satisfies 4%≤SBT/ET≤50%.

9. The multilayer electronic component of claim 7, wherein a ratio (DEW/BW) of a size in the width direction (DEW) of the dummy electrode, exposed in the length direction, of the cover portion to the size in the width direction (BW) of the band portion satisfies 46%≤DEW/BW≤75%.

10. The multilayer electronic component of claim 9, wherein the DEW and the SBW satisfy 20 μm≤DEW≤SBW.

11. The multilayer electronic component of claim 7, wherein
the body further includes at least one buffer electrode disposed to be spaced apart from the internal electrode in the length direction, the at least one buffer electrode exposed to one of the third and fourth surfaces, and
the side portion is disposed to cover the buffer electrode exposed to one of the third and fourth surfaces.

12. The multilayer electronic component of claim 7, wherein the multilayer electronic component has a length greater than a width.

13. A multilayer electronic component comprising:
a body including a capacitance formation portion including a dielectric layer and an internal electrode alternately disposed with the dielectric layer in a thickness direction, and a cover portion disposed on the capacitance formation portion in the thickness direction, the body having first and second surfaces opposing each other in the thickness direction, third and fourth surfaces connected to the first and second surfaces, the third and fourth surfaces opposing each other in a length direction, and fifth and sixth surfaces connected to the first to fourth surfaces, the fifth and sixth surfaces opposing each other in a width direction; and
an external electrode including a connection portion disposed on the fifth and sixth surfaces, and a band portion disposed to extend from the connection portion onto the first and second surfaces,
wherein the cover portion includes at least one dummy electrode exposed to at least one of the third and fourth surfaces,
the external electrode includes a side portion extending from the band portion onto at least one of the third and fourth surfaces, the side portion disposed to cover the dummy electrode exposed to at least one of the third and fourth surfaces,
a ratio (SBT/ET) of a size in the thickness direction (SBT) of the side portion to a size in the thickness direction (ET) of the external electrode satisfies 7%≤SBT/ET≤50%, and
a thickness (T) of the multilayer electronic component satisfies 0.05 mm≤T≤0.3 mm.

14. The multilayer electronic component of claim 13, wherein a ratio (DEW/BW) of a size in the width direction (DEW) of the dummy electrode, exposed in the length direction, of the cover portion to a size in the width direction (BW) of the band portion satisfies 40%≤DEW/BW≤75%.

15. The multilayer electronic component of claim 14, wherein a ratio (SBW/BW) of a size in the width direction (SBW) of the side portion to the size in the width direction (BW) of the band portion satisfies 40%≤SBW/BW≤100%.

16. The multilayer electronic component of claim 15, wherein the DEW and the SBW satisfy 20 μm≤DEW≤SBW.

17. The multilayer electronic component of claim 13, wherein
the body further includes at least one buffer electrode disposed to be spaced apart from the internal electrode in the length direction, the at least one buffer electrode exposed to one of the third and fourth surfaces, and
the side portion is disposed to cover the buffer electrode exposed to one of the third and fourth surfaces.

18. The multilayer electronic component of claim 13, wherein the multilayer electronic component has a length greater than a width.
